(19) United States
(12) Patent Application Publication
(10) Pub. No.: US 2009/0126219 A1
(43) Pub. Date: May 21, 2009

(54) Method and System for Drying High-Moisture Content Plant Material

(75) Inventors: Oscar Lee Mathis, JR., Cary, IL (US); Steve C. Wiechmann, Sleepy Hollow, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: GENERAL KINEMATICS CORPORATION, Crystal Lake, IL (US)

(21) Appl. No.: 12/272,083

(22) Filed: Nov. 17, 2008

Related U.S. Application Data
(60) Provisional application No. 60/989,004, filed on Nov. 19, 2007.

(51) Int. Cl. F26B 3/00; F26B 19/00; F26B 9/00

(52) U.S. Cl. 34/446; 34/549; 34/164

(57) ABSTRACT

A system includes a container having a curved inner surface disposed about a generally horizontally extending longitudinal axis, the container having an input end and an axially-spaced output end opposite the input end, the container being mounted on a plurality of resilient members so as to be resiliently supported above a base. The curved inner surface is defined by at least one deck plate having a plurality of apertures to direct air tangential to the curved inner surface. The system also includes a vibration generator coupled to the container for producing a vibratory force to cause material within the container to be moved in a generally rising and falling path of rolling movement along the curved inner surface, and a fan coupled to a heater and to the plurality of apertures to pass heated air through the plurality of apertures. A method of drying material is also provided.

This application claims the benefit of U.S. Application No. 60/989,004, filed Nov. 19, 2007, which is hereby incorporated by reference in its entirety in the present application.

### BACKGROUND

This patent is directed to a method and a system for drying high-moisture content plant material, and, in particular, to a method and a system for drying a high-moisture content plant material utilizing vibratory equipment.

In the emerging market for alternative energy resources, considerable interest has developed in producing energy resources from plant material. Energy resources developed from plant materials (biomass) would have the benefit of being renewable, i.e., being replenished in a short amount of time, as opposed to fossil fuels that take many centuries to develop. Additionally, energy resources developed from biomass may utilize materials that would otherwise be considered to be “waste” products and be disposed of in landfills. Consequently, the development of energy resources from biomass might answer two questions at once: how to provide the energy requirements of a growing global population and how to limit the impact of that growing population on the environment in which it lives.

In fact, methods have been developed to take plant materials, such as grasses, and convert this material into biofuel. Grasses may be harvested particularly for this purpose. However, more commonly, the grasses intended for use in the production of biofuels are the “waste” products of maintenance and groundskeeping activities. As one example, the grasses used to make biofuels may be collected when a state organization conducts maintenance operations (e.g., mowing) in and around roads, highways, etc.

Unfortunately, the grasses collected from mowing are not in the optimal condition to be processed into a biofuel. Grasses typically have high moisture content. This may make the grasses undesirable for processing chemically into a biofuel. Additionally, the high moisture content may also make the grasses difficult to process mechanically into a more manageable form. For example, cutting freshly mown grass to reduce its size further is complicated by the high moisture content of the grass. Furthermore, the grasses typically carry with and on them a fair amount of other materials, such as dirt, sand, stone, etc., that further complicate the mechanical and chemical processing of the grass into a biofuel.

It has been attempted to dry the grasses to remove at least some of the moisture content to overcome some of the problems in processing. In particular, belt dryers have been used wherein hot air is directed through a bed of mown grass to attempt to dry the grass. However, the bed of grass will typically have a temperature and moisture profile, meaning that certain portions of the bed will be hotter and moister than other regions of the bed. Furthermore, these localized conditions are made worse with the increasing depth of the bed, requiring a shallow bed to be used. Additionally, the individual blades of grass must be pre-cut on the order of 20 mm (⅞ inch) to permit efficient drying of the grass. This pre-cutting of the grass is complicated, as explained above, by the high moisture content of the grass when recently mown and the presence of debris, such as sand, dirt, and stone, in with the mown grasses.

Consequently, it is desired to have alternative apparatuses and methods for drying high-moisture content plant materials.

### SUMMARY

According to an aspect, a system includes a container having a curved inner surface disposed about a generally horizontally extending longitudinal axis, the container having an input end and an axially-spaced output end opposite the input end, the container being mounted on a plurality of resilient members so as to be resiliently supported above a base. The curved inner surface is defined by at least one deck plate having a plurality of apertures to direct air tangential to the curved inner surface. The system also includes a vibration generator coupled to the container for producing a vibratory force to cause material within the container to be moved in a generally rising and falling path of rolling movement along the curved inner surface. Further, the system includes a fan coupled to a heater and to the plurality of apertures to pass heated air through the plurality of apertures.

According to another aspect, a method of drying material in a container is provided. The container has a curved inner surface disposed about a generally horizontally extending longitudinal axis, an input end and an axially-spaced output end opposite the input end, the curved inner surface defined by at least one deck plate having a plurality of apertures to direct air tangential to the curved inner surface. The method includes heating air to create heated air, directing the heated air through the plurality of apertures, and vibrating the container to cause material within the container to be moved in a generally rising and falling path of rolling movement along the curved inner surface.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a front view of an apparatus for drying high-moisture content plant material according to the present disclosure, with air plenum and exhausts removed;

FIG. 2 is an end view of the apparatus of FIG. 1;

FIG. 3 is a rear view of the apparatus of FIG. 1;

FIG. 4 is a schematic view of the apparatus of FIG. 1 in combination with air plenum, exhausts and auxiliary equipment to dry high-moisture content plant material;

FIG. 5 is a cross-section of a mechanism for creating tangential air flow along the surface of the drum of the apparatus of FIG. 1; and

FIG. 6 is a cross-section of another mechanism for creating tangential air flow along the surface of the drum of the apparatus of FIG. 1.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

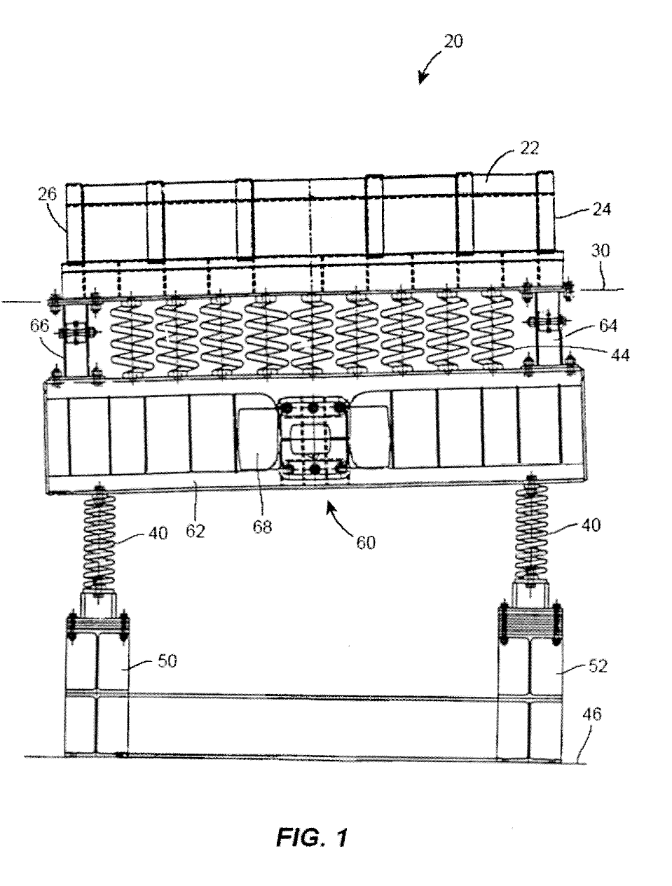

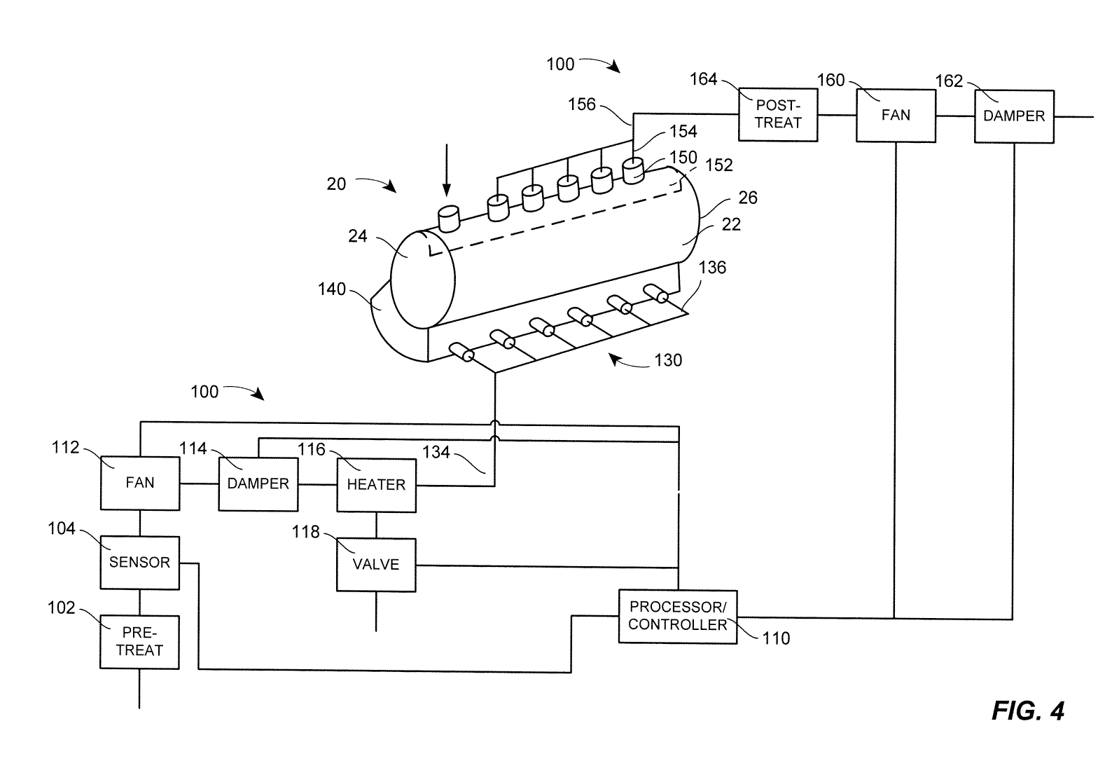

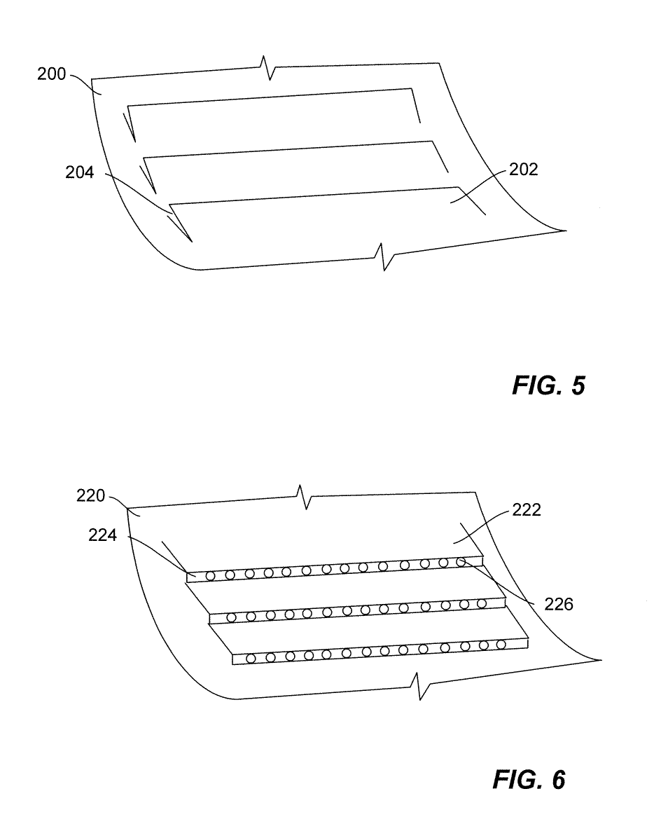

The method and system for drying high-moisture content plant material is illustrated in FIGS. 1-6. The method and system utilizes a vibratory apparatus, such as illustrated in FIGS. 1-3, in combination with a fluid (e.g., air) flow system, such as illustrated in FIG. 4. Exemplary mechanisms for introducing the air into the vibratory apparatus are illustrated in FIGS. 5 and 6. To facilitate understanding of the system and method, the vibratory apparatus is first discussed as to its structure and operation separate from the air flow system, with reference to FIGS. 1-3, and then in context with the remainder of the air flow system, with reference to FIGS. 4-6.

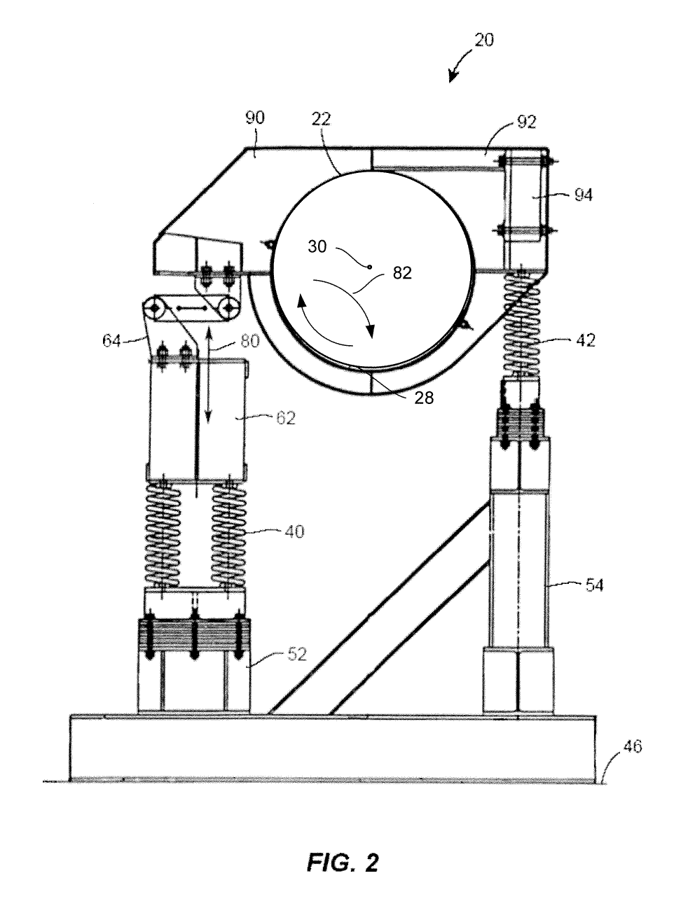

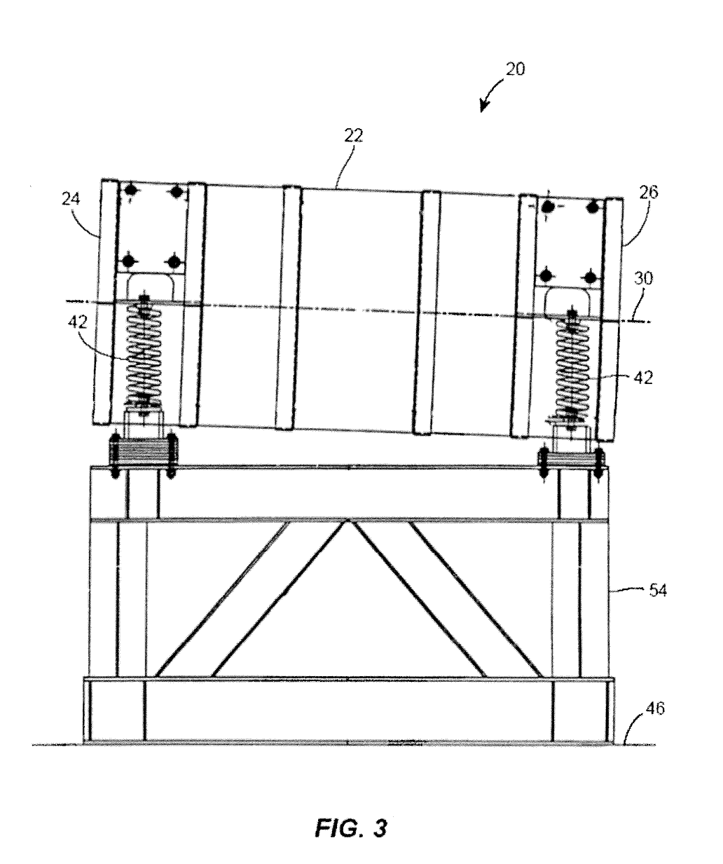

Referring the first to FIG. 1, a vibratory apparatus 20 useful according to the present disclosure includes a cylindrical drum or container 22. The container 22 has an input end 24, and an axially-spaced output end 26 opposite the input end 24. As seen in FIG. 2, the container 22 has a curved inner surface 28 disposed about a generally horizontally extending longitudinal axis 30 (appearing as a point in FIG. 2, and as a line in FIGS. 1 and 3).

The container 22 is mounted on a plurality of resilient members, or springs, 40, 42, 44 so as to be resiliently supported above a base 46. The springs 40 isolate the container 22 from the base 46 on one side, while the springs 42 isolate the container 22 from the base 46 on the other side. The springs 40, 42 may be set apart from the base 46 by, for example, steel columns 50, 52 (FIG. 1) and a steel support structure 54 (FIGS. 2 and 3), respectively.

The apparatus 20 also includes a vibratory generator 60. While an exemplary embodiment of a vibratory generator is discussed below, it will be recognized that other generators may be used as well. For example, an alternative generator may not have the motors mounted on the apparatus, but on a stationary support structure instead. The motors may be coupled to and drive rotating eccentric weights mounted on the apparatus, however.

Returning then to FIGS. 1 and 2, the vibratory generator 60 may comprise a beam 62 that spans the springs 40. The beam 62 is coupled to the container 22 by rocker leg assemblies 64, 66, disposed generally at or near the input end 24 and the output end 26, respectively. Typically, rocker leg assemblies may be distributed along the length of the beam 62. The beam 62 is also coupled to the container 22 by the springs 44, which springs 44 span the beam 62 between the rocker leg assembly 64 and the rocker leg assembly 66. In this manner, the container 22 has freedom of movement constrained only by the rocker leg assemblies 64, 66 and the springs 44 in response to a vibratory force produced by the vibratory generator 60. In addition, the vibratory generator 60 may include a pair of eccentric weight motors mounted on opposite sides of the beam 62, one of which is shown in FIG. 1 at 68.

The vibratory force produced by the vibratory generator 60 is generally represented by the double-ended arrow 80 in FIG. 2. It will be recognized that the vibratory force 80 is directed generally along a linear path which is (i) displaced from the generally horizontally extending longitudinal axis 30 and (ii) displaced from the center of gravity of the container 22. As will also be appreciated, the plurality of resilient members 40, 42, 44 mount the container 22 for unconstrained vibratory movement in response to the vibratory force 80 produced by the vibratory generator 60.

The vibratory force 80 causes objects to move within the container 22. Objects placed in the container 22 are moved in a generally rising and falling path of rolling movement along the curved inner surface 28 of the container 22, as generally represented by the pair of arrows 82 in FIG. 2. The rolling movement occurs as the objects are being transported in the direction of the generally horizontally extending longitudinal axis 30 from the input end 24 toward the output end 26 of the container 22.

To assist the movement of the objects along the axis 30, the container 22 may be mounted such that the generally horizontally extending longitudinal axis 30 is actually inclined downwardly from the input end 24 to the output end 26. The downward inclination of the container 22 causes the objects to be transported, in part, by gravity from the input end 24 toward the output end 26. However, it will be recognized that this inclination is not required in all embodiments of the present disclosure.

It will be recognized from FIG. 2, for example, that the container 22 may include a pair of outwardly extending arms 90, 92. The arms 90, 92 may each include an integrally associated ballast weight, such as the weight 94 (see FIG. 2) that is on the side of the container 22 opposite the vibratory generator 60. The ballast weights assist in producing the vibratory force 80, and the vibratory force 80 may be modified by modifying, for example, the placement and size of the ballast weights.

Reference is now made to FIG. 4, wherein the drum 22 of the apparatus 20 is illustrated in combination with a fluid flow system 100. To simplify the illustrations, only the drum 22 of the apparatus 20 is illustrated in FIG. 4. However, it should be recognized that the apparatus 20 would be assembled in accordance with the disclosure of FIGS. 1-3, and that the plenums, exhausts and other elements of the fluid flow system 100 would be assembled so as to permit the apparatus 20 to operate as discussed above.

According to the exemplary embodiment illustrated in FIG. 4, the working fluid used in the fluid flow system 100 is air. Other gaseous fluids may be used in alternative embodiments. However, it is believed that air may be a suitable fluid to be used in accordance with the apparatus 20 and system 100.

Air is drawn into the system 100 through a pretreatment stage 102. The pretreatment stage 102 may include a filter, for example. The filter may be selected according to the desired characteristics of the air that will be introduced into the drum 22. For that matter, other equipment may be included in the pretreatment stage, such as dehumidifiers and the like.

Air passes from the pre-treatment stage 102 through a sensor or monitor 104. The sensor 104 is coupled to a processor/controller 110. The sensor 104 provides a signal to the processor/controller 110 representative of the flow of the air through the sensor 104.

The air is drawn into a fan 112, the output of which is coupled a damper 114. The combination of the fan 112 and the damper 114 force air into the drum 22, as explained in greater detail below. The fan 112 and/or the damper 114 are connected to the processor/controller 110, and the processor/controller 110 may adjust the fan and/or the damper 114 in response to the signals received from the sensor/monitor 104. Alternative mechanisms for providing a controlled air stream may be substituted for this exemplary combination; for example, a variable frequency drive (VFD) may be used in conjunction with the fan 112 to control the speed of the fan 112 to control the flow of air into the drum 22.

The air passing the damper 114 is received by a heater 116. The heater 116 increases the temperature of the air in preparation for its introduction into the drum 22. The heater 116, or a valve 118 in a fuel line connected to the heater 116, may be connected to the processor/controller 110. The processor/controller 110 may also be coupled to a temperature sensor disposed at the output of the heater 116 and to a temperature sensor disposed within the drum 22. The processor/controller 110 controls the valve 118 in accordance with the signals received from the temperature sensors.

The output of the heater 116 is directed into a conduit or a plurality of conduits 130. As illustrated, the plurality of conduits 130 includes a main conduit 134 from which a number of auxiliary conduits 136 depend. The auxiliary conduits 136 are coupled to a plenum 140, which is disposed beneath and coupled to the drum 22. Because of the motion of the drum 22, one or more flexible couplings are used in the main conduit 134 or auxiliary conduits 136. One or more dampers may also be disposed in the auxiliary conduits 136 to provide further control of the air entering the plenum 140.

The plenum 140 may include a plurality of separate chambers, each associated with one of the auxiliary conduits 136. The air from the plenum 140 is, in turn, passed into a mechanism for creating tangential air flow along the surface of the drum 22. Two such mechanisms for creating tangential air flow are illustrated in FIGS. 5 and 6. FIG. 5 illustrates a deck plate 200 including a plurality of louvers 202 that define a plurality of slot-like apertures 204. The deck plate 200 is oriented in the direction that it might be disposed within the drum 22 as the drum 22 is illustrated in FIG. 4. FIG. 6 illustrates a deck plate 220 including a plurality of steps 222 having a surface 224 in which a plurality of hole-like apertures 226 is formed. The deck plate 220 is reversed relative to the direction in which it would be oriented when disposed within the drum 22 of FIG. 4 so as to better illustrate the apertures 226.

Air is removed from the drum 22 through one or more exhausts 150. To guide or direct the air into these exhausts, a deflector 152 is disposed in the drum 22. The deflector 152 is coupled to the surface of the drum longitudinally. The deflector 152 may create a centrifugal force on the particulate suspended in the air stream to direct the particulate back to the bed of material in the drum 22, with the air reversing direction to enter the exhausts 150. The exhausts 150 are coupled to a plurality of auxiliary conduits 154 that feed into a main conduit 156.

A fan 160 and associated damper 162 are used to remove a controlled air stream from the drum 22 through the exhausts 150 and conduits 154, 156. Similar to the fan 112 and damper 114, the fan 160 and/or damper 162 may be coupled to the processor/controller 110. The processor/controller 110 is also coupled to a static pressure sensor disposed within the drum, and controls the fan 160 and/or damper 162 to adjust the flow of air exiting the drum 22 so as to maintain, for example, a slight negative pressure within the interior of the drum 22 to limit the release of hot air and/or particulate into the operating environment about the system 100, and particularly the drum 22. Here as well, alternatives are possible for the combination of fan 160 and damper 162, such as the use of a variable frequency drive (VFD) with the fan 160.

As also illustrated, a post-treatment stage 164 may be disposed upstream of the fan 160. Such a post-treatment stage 164 may include a heat exchanger to reduce the temperature of the air stream exiting the system 100. Such a post-treatment stage 164 may also include a cyclonic dust separator, to remove debris that may have become entrained in the air stream as the air passes through the interior of the drum 22.

In operation, heated air is forced into the drum 22 through the mechanisms for creating tangential air flow. At the same time, the material in the plant material drum, freshly cut grasses according to one embodiment of the present disclosure, is following a rolling motion in accordance with the action of the vibratory generator 60. The tangential air flow is thus in the same clockwise direction as the motion of the material within the drum 22, as illustrated in FIG. 2.

It is believed that the heated air entering the drum in a tangential flow direction may have at least two effects on the motion of the material in the drum 22. First, the air flow reinforces the rolling motion of the material in the drum 22. Second, the air flow assists in the mixing of the material in the drum 22.

It is believed that these motion patterns may have several benefits, one or more of which may be present in an embodiment according to the present disclosure. The mixing of the material prevents “slugging” of the material in the drum 22. The prevention of slugging contributes to a more even distribution of temperature in the material in the drum 22, and a more even distribution of moisture as a consequence.

A more even distribution of temperature and moisture is significant relative to the amount of material that may be processed at a single time. That is, with belt dryers, the presence of a definite temperature and moisture profile in the grasses being dried limits the depth of the grass bed. However, with more even distributions of temperature and moisture, deeper beds may be used because there is not the same concern relative to localized hot spots and resultant fire risk. Deeper beds permit more material to be processed at a single time, and longer treatment periods within the drum 22.

It is believed that the mixing action provided by the tangential air stream will permit a wider range of grass blade lengths to be dried than is presently the case with conventional belt dryers. That is, rather than requiring that the grass be cut to a length of approximately 20 mm (7/8 inch) prior to introduction into the drying apparatus, it is believed that the present system may accommodate blade lengths on the order of 460 mm to 610 mm (I 8 to 24 inches), which is more typical of the lengths of grasses and other plant materials as they are collected from mowing

operations. Also, by reducing the amount of mechanical processing required prior to drying, the problems with such processing (difficulty in cutting high moisture content grasses, presence of sand, dirt, stones, etc.) may be reduced.

In fact, the method and system for drying described herein may permit the grasses to be cut after they are discharged from the dryer, instead of before they are introduced into the dryer. The grasses have a much lower moisture content at that point, making the grasses easier to cut. Furthermore, the dried grasses may be easier to separate from debris, such as sand, dirt or stones than the wet grasses.

What is claimed is:

1. A system comprising:
a container having a curved inner surface disposed about a generally horizontally extending longitudinal axis, the container having an input end and an axially-spaced output end opposite the input end, the container being mounted on a plurality of resilient members so as to be resiliently supported above a base,
the curved inner surface defined by at least one deck plate having a plurality of apertures to direct air tangential to the curved inner surface;
a vibration generator coupled to the container for producing a vibratory force to cause material within the container to be moved in a generally rising and falling path of rolling movement along the curved inner surface; and
a fan coupled to a heater and to the plurality of apertures to pass heated air through the plurality of apertures.

2. The system according to claim 1, wherein the at least one deck plate comprises a plurality of louvers, each louver defining one of the plurality of apertures.

3. The system according to claim 1, wherein the at least one deck plate comprises a plurality of steps, each step defining at least one of the plurality of apertures.

4. The system according to claim 1, wherein the plurality of apertures is oriented so that the direction of the air flow is in the same direction as the path of rolling movement of material in the drum.

5. The system according to claim 1, further comprising a plenum disposed beneath the container and coupled to the container, the plenum in fluid communication with the plurality of apertures and coupled to the output of the fan and the heater.

6. The system according to claim 1, further comprising a first temperature sensor disposed at the output of the heater, a second temperature sensor disposed within the container, and a controller coupled to first and second temperature sensors and the heater, the controller adjusts the heater in response to a signal received from the first and second temperature sensors.

7. The system according to claim 1, further comprising a damper coupled to the output of the fan and an air flow sensor, the controller coupled to the damper and the air flow sensor, the controller adjusts the damper in response to a signal received from the air flow sensor.

8. The system according to claim 1, further comprising at least one exhaust coupled to the container to remove air from the container, and a deflector disposed in the drum and coupled to the surface of the drum adjacent the at least one exhaust.

9. The system according to claim 8, further comprising another fan coupled to the at least one exhaust, another damper coupled to output of the another fan and a static pressure sensor disposed within the drum, the controller coupled to the another damper and the static pressure sensor, the controller adjusts the another damper in response to a signal received from the static pressure sensor.

10. The system according to claim 1, wherein the container is defined by a cylindrical drum.

11. A method of drying material in a container having a curved inner surface disposed about a generally horizontally extending longitudinal axis, an input end and an axially-spaced output end opposite the input end, the curved inner surface defined by at least one deck plate having a plurality of apertures to direct air tangential to the curved inner surface, the method comprising:
heating air to create heated air;
directing the heated air through the plurality of apertures; and
vibrating the container to cause material within the container to be moved in a generally rising and falling path of rolling movement along the curved inner surface.

12. The method according to claim 11, further comprising directing the heated air through the plurality of apertures and vibrating the container so that the heated air and the path of rolling movement are in the same direction.

13. The method according to claim 11, comprising:
sensing the temperature of the heated air;
sensing the temperature of the air in the container; and
adjusting the temperature of the heated air.

14. The method according to claim 11, comprising:
sensing the flow of heated air directed into the container; and
adjusting the flow of heated air directed into the container.

15. The method according to claim 11, comprising:
sensing the pressure within the container;
adjusting the flow of air exiting the container to maintain a slight negative pressure within the container.

16. The method according to claim 11, comprising:
directing wet plant material into the container.

17. The method according to claim 16, comprising:
directing wet grass material having blade lengths on the order of 460 mm to 610 mm (18 to 24 inches) into the container.
